(19) United States
(12) Patent Application Publication
(10) Pub. No.: US 2018/0149773 A1
(43) Pub. Date: May 31, 2018

(54) OPTICAL ELEMENT AND OPTICAL SYSTEM INCLUDING THE SAME

(71) Applicant: CANON KABUSHIKI KAISHA, Tokyo (JP)

(72) Inventor: Hironobu Koga, Utsunomiya-shi (JP)

(21) Appl. No.: 15/820,106

(22) Filed: Nov. 21, 2017

(30) Foreign Application Priority Data
Nov. 30, 2016 (JP) 2016-233243

(51) Int. Cl. G02B 1/11; G02B 7/02

(52) U.S. Cl. CPC G02B 1/11; G02B 7/021

(57) ABSTRACT

An optical element includes a substrate, an antireflection film provided on the substrate, and an absorption layer provided between the substrate and the antireflection film. The optical element satisfies the following conditional expressions:

0.01≤k(λ₅₅₀)≤0.15 and

k(λ₄₀₀)/λ₄₀₀<k(λ₇₀₀)/λ₇₀₀,

where k(λ) is an extinction coefficient of the absorption layer at a wavelength λ, λ₅₅₀ is a wavelength of light having a wavelength of 550 nm, λ₄₀₀ is a wavelength of light having a wavelength of 400 nm, and λ₇₀₀ is a wavelength of light having a wavelength of 700 nm. The absorption layer absorbs at least part of light incident thereupon to correct coloring of transmitted light.

### BACKGROUND OF THE INVENTION

### Field of the Invention

The present invention relates to an optical element used in an optical system such as a digital camera.

### Description of Related Art

An optical element such as a lens in an optical system may absorb light having a specific wavelength, whereby light having passed through the optical system may be colored. Particularly, it is known that transmitted light is colored yellow in an optical system using high-dispersion glass.

Coloring of transmitted light can be corrected by providing the optical system with an optical element that reduces the transmittance of light in a wavelength band that causes coloring. United States Patent Publication Application No. US 2005/0036215 discusses an optical element in which the reflectance on the long-wavelength side is made larger than the reflectance on the short-wavelength side to correct yellow coloring of transmitted light in an optical system.

However, since the optical element discussed in United States Patent Publication Application No. US 2005/0036215 corrects the coloring of transmitted light by increasing the reflectance on the long-wavelength side, flare and ghost artifacts may occur when the optical element is used in an imaging optical system.

### SUMMARY OF THE INVENTION

The present invention is directed to providing an optical element having low reflectance that can correct coloring of transmitted light in an optical system.

According to an aspect of the present invention, an optical element includes a substrate, an antireflection film provided on the substrate, and an absorption layer that is provided between the substrate and the antireflection film and absorbs part of incident light, wherein the optical element satisfies the following conditional expressions:

0.01≤k(λ550)≤0.15 and

k(λ400)/λ400<k(λ700)/λ700,

where k(λ) is an extinction coefficient of the absorption layer at a wavelength λ, λ400 is a wavelength of light having a wavelength of 400 nm, λ550 is a wavelength of light having a wavelength of 550 nm, and λ700 is a wavelength of light having a wavelength of 700 nm.

According to another aspect of the present invention, an optical element includes a substrate, an antireflection film provided on the substrate, and an absorption layer that is provided between the substrate and the antireflection film and absorbs part of incident light, wherein the absorption layer includes a titanium oxide with a ratio of oxygen atoms to titanium atoms smaller than 2 and equal to or larger than 3/2.

Further features of the present invention will become apparent from the following description of exemplary embodiments with reference to the attached drawings.

### BRIEF DESCRIPTION OF THE DRAWINGS

FIG. 1 is a schematic view of an optical element according to a first exemplary embodiment.

FIGS. 2A and 2B are graphs illustrating wavelength characteristics of an extinction coefficient and a refractive index of a titanium oxide layer.

FIGS. 3A and 3B are graphs illustrating wavelength characteristics of an extinction coefficient and a refractive index of a titanium oxide layer different from the layer illustrated in FIGS. 2A and 2B.

FIGS. 4A, 48, and 4C are graphs illustrating wavelength characteristics of an extinction coefficient and a refractive index of an absorption layer in an optical element according to an exemplary embodiment of the present invention.

FIGS. 5A, 5B, and 5C are diagrams illustrating a wavelength characteristic of reflectance, a wavelength characteristic of transmittance, and the ISO color contribution index (ISO/CCI) in the optical element according to the first exemplary embodiment.

FIGS. 6A, 6B, and 6C are diagrams illustrating a wavelength characteristic of reflectance, a wavelength characteristic of transmittance, and the ISO/CCI in an optical element according to a second exemplary embodiment.

FIG. 7 is a schematic view of an optical element according to a third exemplary embodiment.

FIGS. 8A, 8B, and 8C are diagrams illustrating a wavelength characteristic of reflectance, a wavelength characteristic of transmittance, and the ISO/CC in the optical element according to the third exemplary embodiment.

FIGS. 9A and 9B, and 9C are diagrams illustrating a wavelength characteristic of reflectance, a wavelength characteristic of transmittance, and the ISO/CCI in an optical element according to a fourth exemplary embodiment.

FIGS. 10A, 10B, and 10C are diagrams illustrating a wavelength characteristic of reflectance, a wavelength characteristic of transmittance, and the ISO/CCI in an optical element according to a fifth exemplary embodiment.

FIGS. 11A, 11B, and 11C are diagrams illustrating a wavelength characteristic of reflectance, a wavelength characteristic of transmittance, and the ISO/CCI in an optical element according to a sixth exemplary embodiment.

FIGS. 12A, 12B, and 12C are diagrams illustrating a wavelength characteristic of reflectance, a wavelength characteristic of transmittance, and the ISO/CCI in an optical element according to a seventh exemplary embodiment.

FIG. 13 is a schematic view of an optical element according to an eighth exemplary embodiment.

FIGS. 14A, 14B, and 14C are diagrams illustrating a wavelength characteristic of reflectance, a wavelength characteristic of transmittance, and the ISO/CCI in the optical element according to the eighth exemplary embodiment.

FIGS. 15A, 15B, and 15C are diagrams illustrating a wavelength characteristic of reflectance, a wavelength characteristic of transmittance, and the ISO/CCI in an optical element according to a ninth exemplary embodiment.

FIGS. 16A, 16B, and 16C are diagrams illustrating a wavelength characteristic of reflectance, a wavelength characteristic of transmittance, and the ISO/CCI in an optical element according to a tenth exemplary embodiment.

FIG. 17 is a cross-sectional view of an optical system.

FIG. 18 is a graph illustrating a wavelength characteristic of transmittance in a case where only absorption of light by each lens is taken into account in the optical system illustrated in FIG. 17.

FIG. 19 is a diagram illustrating the ISO/CCI of the optical system illustrated in FIG. 17.

### DESCRIPTION OF THE EMBODIMENTS

Hereinafter, exemplary embodiments of the present invention will be described.

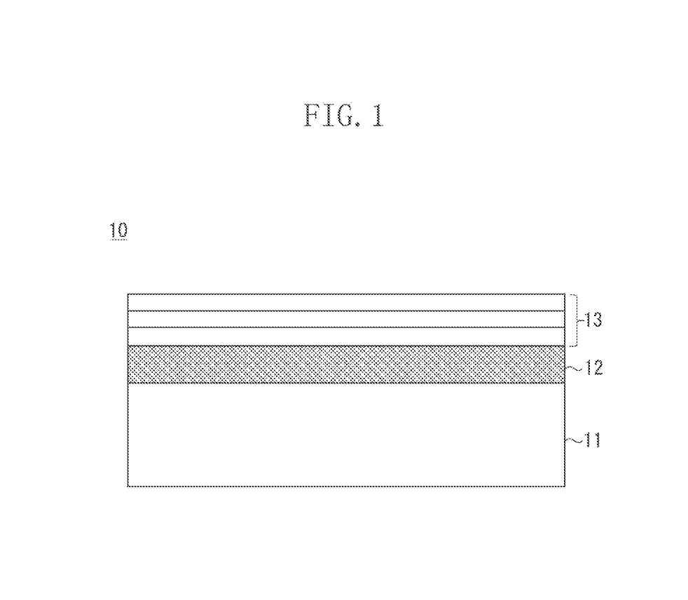

FIG. 1 is a schematic view of an optical element 10 according to a first exemplary embodiment. The optical element 10 includes a substrate 11 and an antireflection film 13 provided on the substrate 11. An absorption layer 12 is provided between the substrate 11 and the antireflection film 13.

The substrate 11 may be a parallel plate or may be an optical member having a curvature, such as a lens. The antireflection film 13 includes one or more layers. In the present exemplary embodiment, the antireflection film 13 includes three layers. The absorption layer 12 contains a material that absorbs light at a specific wavelength for wavelength band), and part of light incident on the optical element 10 is absorbed by the absorption layer 12.

A glass material used for the optical system slightly absorbs visible light. As the dispersion of the glass material increases, the glass material tends to absorb more light on the short-wavelength side than the long-wavelength side. For this reason, in an optical system using high-dispersion glass, transmitted light is colored yellow. To correct the coloring of transmitted light in such an optical system, the optical element 10 includes the absorption layer 12 having such a characteristic as to absorb a larger amount of light on the long-wavelength side than on the short-wavelength side. Specifically, the optical element 10 is designed to satisfy the following conditional expressions (1) and (2):

k(λ₄₀₀)/λ₄₀₀<k(λ₇₀₀)/λ₇₀₀ (1), and

0.01≤k(λ₅₅₀)≤0.15 (2),

where k(λ) represents the extinction coefficient of the absorption layer 12 at a wavelength λ, and λ₄₀₀, λ₅₅₀, and λ₇₀₀ represent the wavelengths of light having wavelengths of 400 nm, 550 nm, and 700 nm respectively.

First, the merits expression (1) will be described.

In a case where light having a wavelength λ and intensity I₀(λ) is incident on the optical element 10, the Intensity I(λ) of transmitted light that has passed through the optical element 10 is expressed by the following expression (3):

I(λ)=I₀(λ)·exp(−4πk(λ)t/λ) (3)

where k(λ) represents the extinction coefficient of the absorption layer 12 and t represents the thickness of the absorption layer 12.

The expression (3), for simplicity, takes into account only the absorption by the absorption layer 12, and excludes the reflection at each interface in the optical element 10 and the absorption of light in the substrate 11.

From the expression (3), the wavelength characteristic (change with respect to wavelength) of transmittance when considering only absorption depends on k(λ)/λ. In other words, the wavelength characteristic of the absorption amount in the absorption layer 12 is determined by the wavelength characteristic of k(λ)/λ. Therefore, the expression (1) indicates that the absorption amount of light having a wavelength of 700 nm is larger than the absorption amount of light having a wavelength of 400 nm in the absorption layer 12. That is, if the absorption layer 12 satisfies the expression (1), the absorption amount of light on the long-wavelength side can be made larger than the absorption amount of light on the short-wavelength side in the absorption layer 12.

Next, the merits of expression (2) will be described.

In general, the reflectance of light at an interface is determined by a refractive index difference and an extinction coefficient difference between two media forming the interface. For example, in the optical element 10, reflectance R of light having a wavelength of 550 nm at the interface between the absorption layer 12 and the substrate 11 is determined by the following expression (4):

R=[(n_{sub}−n_{abs})²+(k(λ₅₅₀)²]/[(n_{sub}+n_{abs})²+(k(λ₅₅₀))²] (4),

where n_{abs} represents the refractive index of the absorption layer 12 at the wavelength of 550 nm and n_{sub} represents the refractive index of the substrate 11 at the wavelength of 550 nm. Since the extinction coefficient of the substrate 11 is much smaller than the extinction coefficient of the absorption layer 12, the extinction coefficient of the substrate 11 is set to 0 in the expression (4).

According to the expression (4), R increases with an increase in k(λ₅₅₀). This also applies to the interface between the absorption layer 12 and the antireflection film 13. To reduce the reflectance of the optical element 10, therefore, it is necessary to form the absorption layer 12 using a material having an appropriate extinction coefficient.

In a case where the extinction coefficient exceeds the upper limit of the expression (2), the reflectance becomes too large. Furthermore, according to the expression (3), the thickness of the absorption layer 12 required to obtain a desired absorption amount becomes smaller as the extinction coefficient of the absorption layer 12 becomes larger. Therefore, in a case where the extinction coefficient of the absorption layer 12 becomes larger than the upper limit of the expression (2), the thickness of the absorption layer 12 becomes too small. This makes it difficult to manufacture the optical element 10.

In a case where the extinction coefficient is lower than the lower limit of the expression (2), on the other hand, the reflectance can be reduced but the thickness of the absorption layer 12 becomes too large. If the thickness of the absorption layer 12 is too large, the film formation time becomes too long at the time of fabricating the absorption layer 12 by vapor deposition or the like. In addition, cracks and film peeling due to film stress of the absorption layer 12 may occur. As a result, it becomes difficult to manufacture the optical element 10.

The value of the expression (2) is desirably in the range of the following expression (2a), and even more desirably in the range of the following expression (2b).

0.01≤k(λ₅₅₀)≤0.10 (2a)

0.01≤k(λ₅₅₀)≤0.05 (2b)

Although the case where only one absorption layer satisfies the expressions (1) and (2) has been described in the present exemplary embodiment, a plurality of absorption layers may be provided as in optical elements of the eighth to tenth exemplary embodiments described below. In this case, all the absorption layers should at least satisfy both of the expressions (1) and (2). In a case where a plurality of absorption layers is provided, a film laminated at a position farther from the substrate than the absorption layer disposed at a position farthest from the substrate among the plurality of absorption layers corresponds to the antireflection film.

Titanium oxide is an exemplary material for forming the absorption layer 12. Examples of titanium oxides include TiO, Ti₂O₃, Ti₃O₃, Ti₄O₇, and TiO₂, which are different in the ratio between titanium atoms and oxygen atoms. TiO₂ is colorless and transparent. TiO, Ti₂O₃, Ti₃O₅, Ti₄O₇ and the like, in which the ratio of oxygen atoms to titanium atoms is smaller than that of TiO₂, absorb visible light. These titanium oxides tend to absorb light more heavily on the long-wavelength side.

In a case of forming the absorption layer 12 using titanium oxide, it is desirable to form the absorption layer 12 using a titanium oxide in which the ratio of oxygen atoms to titanium atoms is smaller than 2 and equal to or greater than 1.5 inclusive. Titanium oxides having the ratio in this range have different extinction coefficients depending on the ratio of oxygen atoms, but satisfy both of the above expressions (1) and (2).

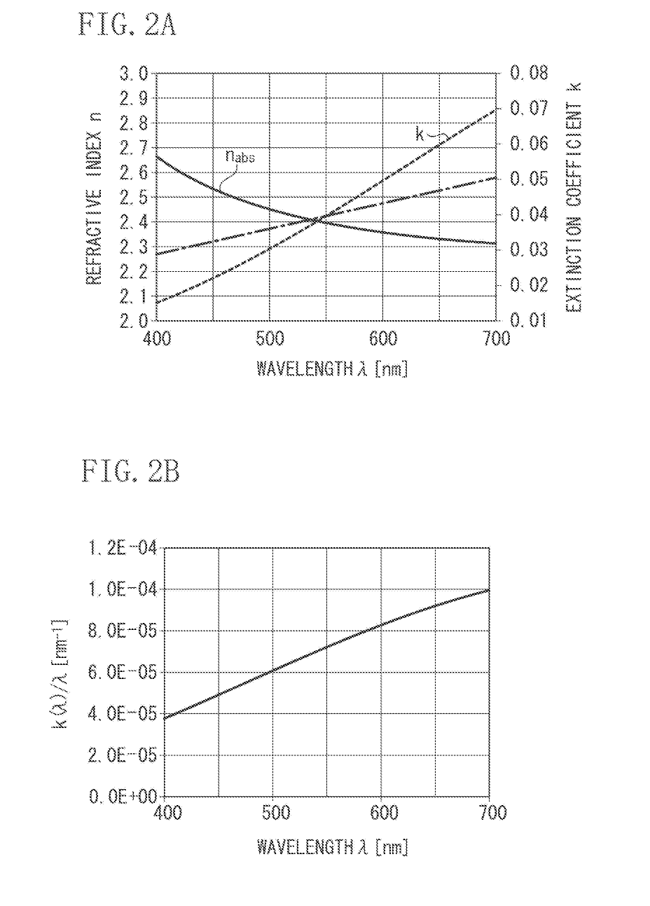

FIG. 2A illustrates wavelength characteristics of a refractive index and an extinction coefficient of a titanium oxide layer (or film) formed by depositing an evaporation material OS-50 (trade name, manufactured by Canon Optron Inc.) mainly containing Ti₃O₅. FIG. 2B illustrates a wavelength characteristic of k(λ)/λ in the titanium oxide illustrated in FIG. 2A. It can be seen that the titanium oxide illustrated in FIGS. 2A and 2B satisfy both of the above expressions (1) and (2).

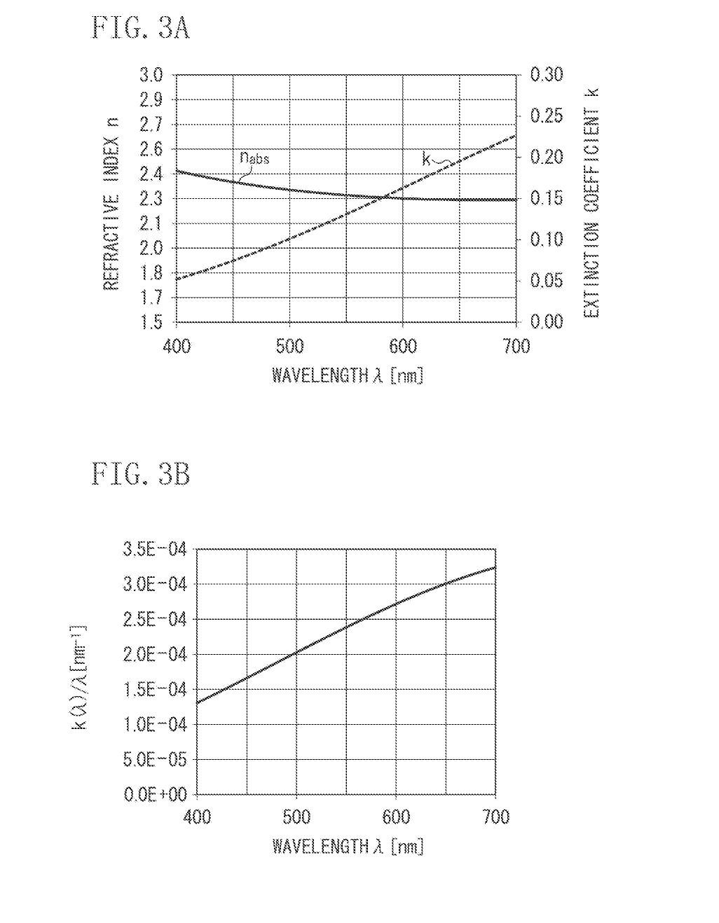

Furthermore, FIG. 3A illustrates wavelength characteristics of a refractive index and an extinction coefficient of a titanium oxide layer obtained in such a manner that the amount of oxygen gas introduced during vapor deposition is made smaller than that when titanium oxide to form the titanium oxide layer illustrated in FIGS. 2A and 2B is deposited. FIG. 3B illustrates a wavelength characteristic of k(λ)/λ in the titanium oxide layer illustrated in FIG. 3A. The parameters illustrated in FIGS. 3A and 3B satisfies both of the expressions (1) and (2), but has a different value of k(λ) and different wavelength characteristics from the titanium oxide illustrated in FIGS. 2A and 2B. In this manner, the magnitude of the extinction coefficient and the wavelength characteristics can be adjusted by adjusting the oxygen gas introduction amount at the time of depositing the titanium oxide. The extinction coefficient can also be adjusted by adjusting a substrate heating temperature during vapor deposition.

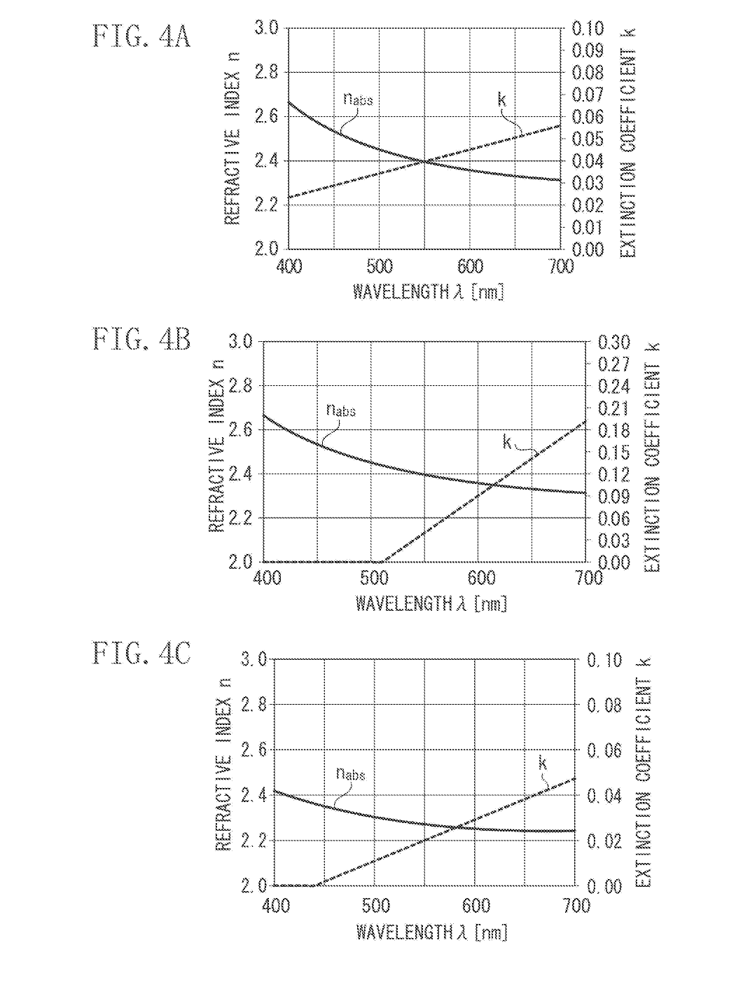

The absorption layer 12 should at least satisfy both of the above expressions (1) and (2), and the material of the absorption layer 12 is not limited to a titanium oxide. The wavelength characteristic of the extinction coefficient of the absorption layer 12 may be those illustrated in FIGS. 4A to 4C. FIGS. 4A to 4C illustrate the wavelength characteristics of an extinction coefficient of a hypothetical material satisfying both of the expressions (1) and (2). FIG. 4A illustrates a case where the extinction coefficient changes substantially linearly relative to a change in the wavelength. FIGS. 4B and 4C illustrate cases where the extinction coefficient is relatively large on the long-wavelength side but extremely small on the short-wavelength side.

The absorption layer 12 desirably satisfies the following expression (5).

1.5≤s·λ₅₅₀/k(λ₅₅₀)≤10 (5)

In the expression (5), “s” is a coefficient of λ when k(λ) is linearly approximated with respect to the wavelength λ by the least squares method at a wavelength of 400 nm to 700 nm. That is, “s” is the gradient of the approximate straight line of k(λ) at the wavelength of 400 nm to 700 nm.

The expression (5) defines the wavelength characteristic of the extinction coefficient of the absorption layer 12 that is required to sufficiently absorb light on the long-wavelength side and suppress a decrease in transmittance. The expression (5) will be described with an example in which the absorption layer 12 is formed of the titanium oxide illustrated in FIG. 2A.

According to the expression (3), in a case where k(λ)/λ is constant irrespective of the wavelength, the absorption amount by the absorption layer 12 is constant irrespective of the wavelength. To absorb a larger amount of light on the long-wavelength side than on the short-wavelength side, k(λ)/λ on the long-wavelength side needs to be larger than k(λ)/λ on the short-wavelength side in the absorption layer 12.

The straight line illustrated by the alternate long and short dashed line in FIG. 2A indicates the wavelength characteristic of the extinction coefficient of a hypothetical material (hereinafter referred to as “non-colored material”) in which the absorption amount is constant irrespective of the wavelength and the extinction coefficient at the wavelength of 550 nm is equal to that of the titanium oxide illustrated in FIG. 2A. At this time, the straight line illustrated by the alternate long and short dashed line in FIG. 2A passes through the coordinates (k(λ₅₅₀), λ₅₅₀) and (0, 0). Therefore, the straight line illustrated by the alternate long and short dashed line is represented as f(λ)=k(λ₅₅₀)×λ/λ₅₅₀. Here, f(λ) represents the wavelength characteristic of the extinction coefficient of the non-colored material.

To increase k(λ)/λ on the long-wavelength side as compared to k(λ)/λ on the short-wavelength side, the extinction coefficient on the short-wavelength side needs to be smaller than f(λ) and the extinction coefficient on the long-wavelength side needs to be larger than f(λ) as in the titanium oxide of FIG. 2A. Therefore, when the extinction coefficient k(λ) of the absorption layer 12 is linearly approximated with respect to the wavelength, the gradient “s” should at least be larger than k(λ₅₅₀)/λ₅₅₀, which is the gradient of the extinction coefficient of the non-colored material with respect to the wavelength.

However, if the value of “s” with respect to k(λ₅₅₀)/λ₅₅₀ decreases to be less than the lower limit of the expression (5), the difference in the absorption amount of light between the short-wavelength side and the long-wavelength side becomes too small. At this time, if it is attempted to sufficiently absorb light on the long-wavelength side, the absorption amount of light on the short-wavelength side also becomes high, and the transmittance of the optical element 10 at a wavelength of 400 nm to 700 nm lowers.

On the other hand, when the value of a with respect to k(λ₅₅₀)/λ₅₅₀ increases to exceed the upper limit of the expression (5), the extinction coefficient on the long-wavelength side becomes too large, and thus the reflectance on the long-wavelength side increases.

The value of the expression (5) is desirably in the range of the following expression (5a), more desirably in the range of the following expression (5b).

2.0≤s·λ₅₅₀/k(λ₅₅₀)≤9.0 (5a)

2.5≤s·λ₅₅₀/k(λ₅₅₀)≤6.0 (5b)

In a case where a plurality of absorption layers is provided as in the eighth to tenth exemplary embodiments described below, all the absorption layers in the optical element desirably satisfy the expression (5).

To facilitate control of the thickness at the time of forming the absorption layer 12, the thickness of the absorption layer 12 is desirably 8 nm or more, more desirably 10 nm or more.

Furthermore, in a case where the optical element 10 is used in an optical system, light reflected by the optical element 10 may reach an image plane and flare or ghost may occur. For this reason, the reflectance of the optical element 10 when light is vertically incident from the antireflection film 13 toward the substrate 11 is desirably 1% or less, more desirably 0.7% or less, for each wavelength of 450 nm to 650 nm.

In addition, the reflectance of the optical element 10 when light is vertically incident from the substrate 11 toward the antireflection film 13 is desirably 1% or less, more desirably 0.7% or less, for each wavelength of 450 nm to 650 nm.

In this manner, by reducing the reflectance for light of a wavelength band to which an ordinary image pickup element or the human eye is highly sensitive among visible light, flare and ghost can be sufficiently reduced in a case where the optical element 10 is used for the optical system.

As described above, the optical element 10 includes the absorption layer 12 that absorbs a larger amount of light on the long-wavelength side than on the short-wavelength side. Here, in a case where the absorptance of the absorption layer 12 on the short-wavelength side is too large, the transmittance of the optical element 10 with respect to visible light becomes too low.

Therefore, the absorptance of the absorption layer 12 on the short-wavelength side desirably does not become too large. Specifically, the following expression (6) is desirably satisfied:

0≤A₄₀₀≤0.1 (6),

where A₄₀₀ represents the absorptance of the absorption layer 12 with respect to light having a wavelength of 400 nm. Absorptance of a material is its effectiveness in absorbing radiant energy; it is the fraction of incident electromagnetic power that is absorbed at an interface. This is different from the absorption coefficient which is the ratio of the absorbed to incident electric field. In optics, partially transparent metal films that are used to increase reflectance are known to absorb a fraction A of the flux density; this fraction is referred to as the absorptance. The absorptance A(λ) of the absorption layer 12 with respect to light having a wavelength λ is a value defined by the following expression (7) using I(λ) and I₀(λ) defined in the expression (3).

A(λ)=−I(λ)/I₀(λ) (7)

If the expression (6) is satisfied, it is possible to correct the coloring of light having passed through the optical system while securing the transmittance of the optical element 10 with respect to visible light.

The value of the expression (6) is desirably in the range of the following expression (6a), more desirably in the range of the following expression (6b).

0≤A₄₀₀≤0.07 (6a)

0≤A₄₀₀≤0.05 (6b)

In the case where the optical element includes a plurality of absorption layers as in the eighth to tenth exemplary embodiments described below, A₄₀₀ represents the absorptance obtained by combining total absorption of light by all the absorption layers in the optical element.

Furthermore, it is assumed that a B value of the ISO color contribution index (ISO/CCI) of the optical element 10 is CCI_{e,B}, a G value thereof is CCI_{e,G}, and an R value thereof is CCI_{e,R}. In addition, the B value of the CCI of only the substrate 11 of the optical element 10 is CCI_{sub,B}, the G value thereof is CCI_{sub,G}, and the R value thereof is CCI_{sub,R}. At this time, the following expressions (8) and (9) are desirably satisfied.

−4.6<(CCI_{e,G}−CCI_{sub,G})−(CCI_{e,B}−CCI_{sub,B})<0 (8)

−4<(CCI_{e,P}−CCI_{sub,P})−[(CCI_{e,G}−CCI_{sub,G})+(CCI_{e,B}−CCI_{sub,B})]×cos 60°<0 (9)

The CCI can be obtained as follows. That is, a red response value R_{P}, a blue response value R_{B}, and a green response value R_{G} are calculated using the spectral transmittance on the optical axis of an optical member for which the CCI is to be obtained and the relative spectral sensitivity determined by ISO 6728. Thereafter, common logarithms log₁₀R_{R}, log₁₀R_{G}, and log₁₀R_{B} of the respective obtained response values are obtained. When the smallest value among the values of log₁₀R_{P}, log₁₀R_{G}, and log₁₀R_{B} is log₁₀Rᵢ, the R value of the CCI is given by log₁₀R_{R}−log₁₀Rᵢ. The G value of the CCI is given by log₁₀R_{G}−log₁₀Rᵢ. The B value of the CCI is given by log₁₀R_{B}−log₁₀Rᵢ.

CCI_{sub,G}, CCI_{sub,B}, and CCI_{sub,R} can be obtained by separately preparing a member of the same material and shape as the substrate 11 and calculating the CCI of the member. The minimum value among CCI_{e,B}, CCI_{e,G}, and CCI_{e,P} is 0. Similarly, the minimum value among CCI_{sub,B}, CCI_{sub,G}, and CCI_{sub,P} is 0.

By taking the difference between the CCI of the optical element 10 and the CCI of only the substrate 11 of the optical element 10, the coloration in the optical element 10 independent of absorption of the substrate 11 can be roughly evaluated by the CCI. Here, the coloration in the optical element 10 independent of absorption of the substrate 11 is coloration due to the wavelength characteristic of the reflectance of the optical element 10 and the wavelength characteristic of absorption by the absorption layer 12.

Normally, the CCI is plotted on a trilinear coordinate system. A value on the vertical axis when the CCI value representing the coloration in the optical element 10 independent of absorption of the substrate 11 is converted into a value on the orthogonal coordinate system is [(CCI_{e,G}−CCI_{sub,G})−(CCI_{e,B}−CCI_{sub,B})]×cos 30°. For this reason, the expression (8) represents a value proportional to the value on the vertical axis when the coloration in the optical element 10 independent of absorption of the substrate 11 is expressed by the CCI and the obtained CCI value is converted into a value on the orthogonal coordinate system. Therefore, the expression (8) defines the range of the value on the vertical, axis when the coloration in the optical element 10 independent of absorption of the substrate 11 is expressed by the CCI and the obtained CCI value is converted into a value on the orthogonal coordinate system.

In addition, the expression (9) defines the range of the value on the horizontal axis when the coloration in the optical element 10 independent of absorption of the substrate 11 is expressed by the CCI and the obtained CCI value is converted into a value on the orthogonal coordinate system.

When the values of both of the expressions (8) and (9) are smaller than 0, it means that the CCI value representing the coloration in the optical element 10 independent of absorption of the substrate 11 is located in the third quadrant in the orthogonal coordinate system. This means that the coloration in the optical element 10 independent of absorption of the substrate 11 is cyan to blue. This makes it possible to correct the tint of yellow-colored light.

Meanwhile, if the upper limit of the expression (8) or (9) is exceeded, it means that the absorptance of the absorption layer 12 has become too large on the long-wavelength side. In this case, the extinction coefficient of the absorption layer 12 on the long-wavelength side becomes much larger than the extinction coefficient on the short-wavelength side, making it difficult to sufficiently reduce the reflectance.

The value of the expression (8) is desirably in the range of the following expression (8a). In addition, the value of the expression (9) is desirably in the range of the following expression (9a).

−4.0<(CCI_{e,C}−CCI_{sub,C})−(CCI_{e,B}−CCI_{sub,B})<−0.1 (8a)

−3.5<(CCI_{e,R}−CCI_{sub,R})−[(CCI_{e,G}−CCI_{sub,G})+(CCI_{e,B}−CCI_{sub,B})]×cos 60°<−0.1 (9a)

Next, preferred conditions for the antireflection film 13 will be described.

To sufficiently reduce the reflectance of the optical element 10 over a wide wavelength band, the antireflection film 13 desirably includes two or more layers.

In addition, the antireflection film 13 desirably includes a layer having a refractive index, at a wavelength of 550 nm, smaller than that of the absorption layer 12 but larger than 1. This makes it possible to reduce the reflectance when light is incident from the antireflection film 13 toward the substrate 11.

As described above, in the case where the optical element includes a plurality of absorption layers, a film disposed at a position farther from the substrate than the absorption layer disposed at a position farthest from the substrate among the plurality of absorption layers corresponds to the antireflection film. In this case, the antireflection film desirably includes a layer having a refractive index, at a wavelength of 550 nm, smaller than the refractive index of the absorption layer disposed at a position farthest from the substrate among the plurality of absorption layers and smaller than 1.

Since the optical element 10 according to the present exemplary embodiment includes the absorption layer 12 that absorbs part of incident light, the reflectance when light is incident from the antireflection film 13 toward the substrate 11 is different from the reflectance when light is incident from the substrate 11 toward the antireflection film 13. Therefore, in a case where the absorption layer 12 is provided at a position in contact with the substrate 11, to reduce the reflectance when light is incident from the substrate 11 toward the antireflection film 13, the following conditional expression (10) is desirably satisfied, where N_{sub} represents the refractive index of the substrate at a wavelength of 550 nm.

|N_{sub}−N_{abs}|≤0.3 (10)

The expression (10) indicates that the difference between the refractive index of the substrate 11 and the refractive index of the absorption layer 12 is small. By satisfying the expression (10), it is possible to reduce the difference in the refractive index at the interface between the substrate 11 and the absorption layer 12, so that the reflectance can be reduced when light is incident from the substrate 11 in a direction toward the antireflection film 13.

Note that the value of the expression (10) is desirably in the range of the following expression (10a).

|N_{sub}−N_{abs}|≤0.2 (10a)

Note that in the case where the optical element includes a plurality of absorption layers as in the optical elements of the eighth to tenth exemplary embodiments described below, the refractive index of the absorption layer adjacent to the substrate should at least be N_{abs} in the expression (10).

Furthermore, to reduce the reflectance when light is incident from the substrate 11 toward the antireflection film 13, an intermediate film (intermediate antireflection film) having one or more layers may be provided between the substrate 11 and the absorption layer 12. At this time, the intermediate film desirably includes a layer having a refractive index, at a wavelength of 550 nm, between the refractive index of the absorption layer 12 and the refractive index of the substrate 11. This makes it possible to reduce the reflectance when light is incident from the substrate toward the antireflection film.

In a case where a plurality of absorption layers described below is provided, a film laminated at a position closer to the substrate than the absorption layer disposed at a position closest to the substrate among the plurality of absorption layers corresponds to the intermediate film. In this case, the intermediate film desirably includes a layer having a refractive index, at a wavelength of 550 nm, between the refractive index of the absorption layer disposed at a position closest to the substrate among the plurality of absorption layers and the refractive index of the substrate.

Next, characteristics of the optical element 10 according to the present exemplary embodiment will be described.

Table 1 indicates the details of each layer in the optical element 10 according to the present exemplary embodiment. In Table 1, n represents a refractive index at a wavelength of 550 nm, k represents an extinction coefficient at a wavelength of 550 nm, and d represents the thickness of each layer.

TABLE 1

| Layer No. | n | k | d [nm] | Remarks |
|---|---|---|---|---|
| — | 1.00000 | 0.0000 | — | Air |
| 4 | 1.38941 | 0.0000 | 101.3 | Antireflection film |
| 3 | 2.11851 | 0.0000 | 39.5 | |
| 2 | 1.63726 | 0.0000 | 21.2 | |
| 1 | 2.39576 | 0.0397 | 21.8 | Absorption layer |
| — | 2.11573 | 0.0000 | — | Substrate |

In the present exemplary embodiment, the absorption layer 12 is formed using a titanium oxide, and the wavelength characteristic of the extinction coefficient thereof is as illustrated in FIGS. 2A and 2B. The extinction coefficient k(λ₅₅₀) of the absorption layer 12, at a wavelength of 550 nm, according to the present exemplary embodiment is 0.0397. In addition, when the extinction coefficient of the absorption layer 12 according to the present exemplary embodiment is linearly approximated with respect to the wavelength by the least squares method and the gradient at this time with respect to the wavelength is “s”, the value of s·λ₅₅₀/k(λ₅₅₀) is 2.579. That is, the absorption layer 12 according to the present exemplary embodiment satisfies the expression (5).

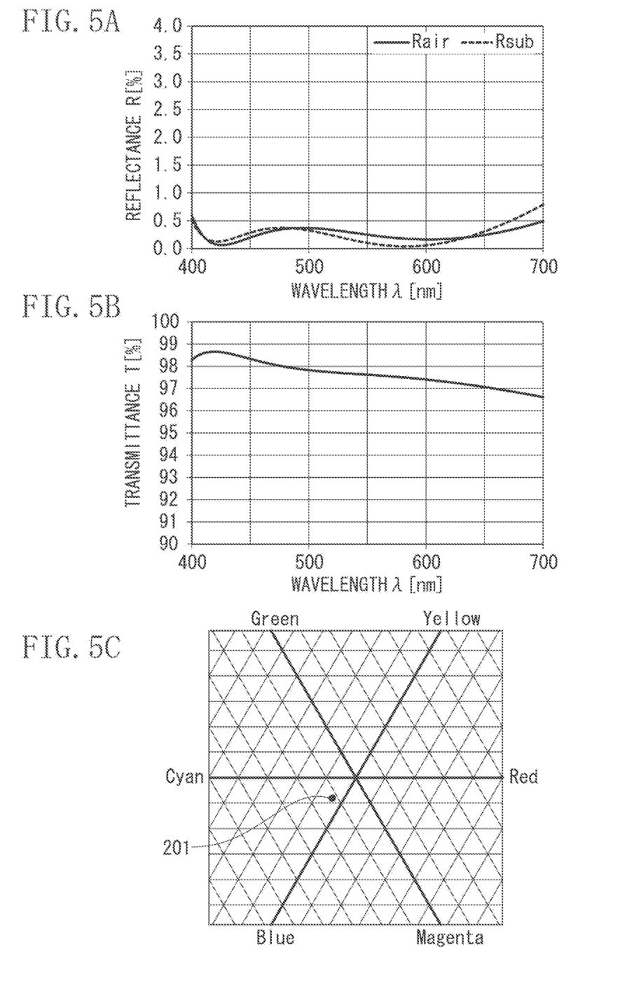

FIG. 5A illustrates the wavelength characteristic of the reflectance of the optical element 10 according to the present exemplary embodiment. In FIG. 5A, the reflectance Rₐᵢᵣ indicated by the solid line is the reflectance when light is incident from the antireflection film 13 toward the substrate 11. In addition, the reflectance R_{sub} indicated by the dotted line is the reflectance when light is incident from the substrate 11 toward the antireflection film 13. As illustrated in FIG. 5A, both Rₐᵢᵣ and R_{sub} of the optical element 10 are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 5B illustrates the wavelength characteristic of the transmittance in the optical element 10. Note that in the wavelength characteristic of the transmittance illustrated in FIG. 5B, the light absorption in the substrate 11 is regarded as zero. The transmittance of the optical element 10 is lower on the long-wavelength side than on the short-wavelength side. Therefore, by using the optical element 10 for the optical system, it is possible to correct the coloring of yellow transmitted light. In addition, the absorptance A₄₀₀ of the absorption layer 12 with respect to light having a wavelength of 400 nm is 0.0104, and the absorption layer 12 according to the present exemplary embodiment satisfies the expression (6).

FIG. 5C illustrates the result of evaluating the wavelength characteristic of the transmittance of the optical element 10 and the wavelength characteristic of the transmittance of only the substrate 11 using the CCI and calculating the values of the expressions (7) and (8), the result being plotted with a black dot 201 on the trilinear coordinate system. In the trilinear coordinate system in FIG. 5C, a grid line is drawn per CCI value. The tint of transmitted light is represented by the direction in which the plot point is located from the origin. In addition, the larger the distance between the origin and the plot point, the higher the intensity of the tint.

The point illustrated in FIG. 5C is plotted in the direction of Blue and Cyan. This indicates that light incident on the optical element 10 is mainly colored by the absorption layer 12 into a bluish color, which is a complementary color of yellow. By using the optical element 10 in the optical system, therefore, it is possible to effectively correct the coloring of the yellow transmitted light.

Next, an optical element according to a second exemplary embodiment will be described. As in the first exemplary embodiment, the optical element according to the second exemplary embodiment includes a substrate, an anti reflect ion film provided on the substrate, and an absorption layer provided between the substrate and the antireflection film. In the optical element according to the present exemplary embodiment, a wavelength characteristic of an extinction coefficient of the absorption layer is different from that of the optical element 10 according to the first exemplary embodiment. The wavelength characteristic of the extinction coefficient of the absorption layer in the present exemplary embodiment is the characteristic illustrated in FIG. 4C.

Details of each layer in the optical element according to the present exemplary embodiment are described in Table 2.

TABLE 2

| Layer No. | n | k | d [nm] | Remarks |
|---|---|---|---|---|
| — | 1.00000 | 0.0000 | — | Air |
| 4 | 1.38941 | 0.0000 | 98.2 | Antireflection film |
| 3 | 2.11851 | 0.0000 | 37.4 | |
| 2 | 1.63726 | 0.0000 | 17.3 | |
| 1 | 2.27112 | 0.0200 | 38.3 | Absorption layer |
| — | 2.11573 | 0.0000 | — | Substrate |

The extinction coefficient k(λ₅₅₀) of the absorption layer, at a wavelength of 550 nm, according to the present exemplary embodiment is 0.0200. In addition, when the extinction coefficient of the absorption layer 12 according to the present exemplary embodiment is linearly approximated with respect to the wavelength by the least squares method and the gradient at this time with respect to the wavelength is “s”, the value of s·λ₅₅₀/k(λ₅₅₀) is 4.718. That is, the absorption layer according to the present exemplary embodiment satisfies the expression (5).

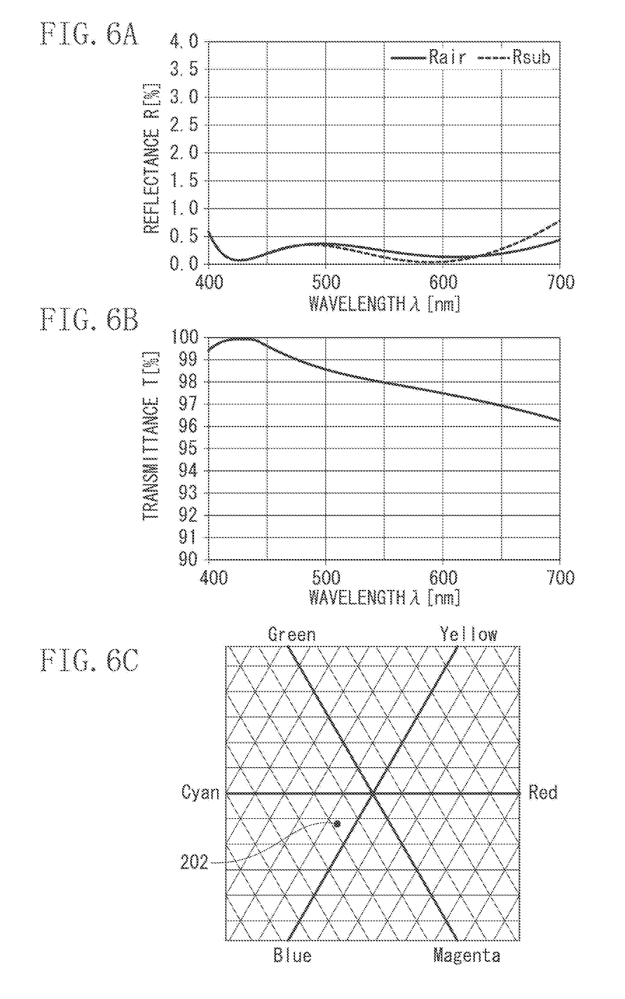

FIG. 6A illustrates the wavelength characteristic of the reflectance of the optical element according to the present exemplary embodiment. As illustrated in FIG. 6A, both Rₐᵢᵣ and R_{sub} of the optical element according to the present exemplary embodiment are 1 or less at a wavelength of 450 nm to 650 nm. In addition, the chance of Rₐᵢᵣ and R_{sub} with respect to the wavelength is small, and the coloring of transmitted light due to the wavelength characteristic of the reflectance is extremely small.

FIG. 6B illustrates the wavelength characteristic of the transmittance of the optical element according to the present exemplary embodiment. In the wavelength characteristic of the transmittance illustrated in FIG. 6B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.

FIG. 6C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 202 on the trilinear coordinate system.

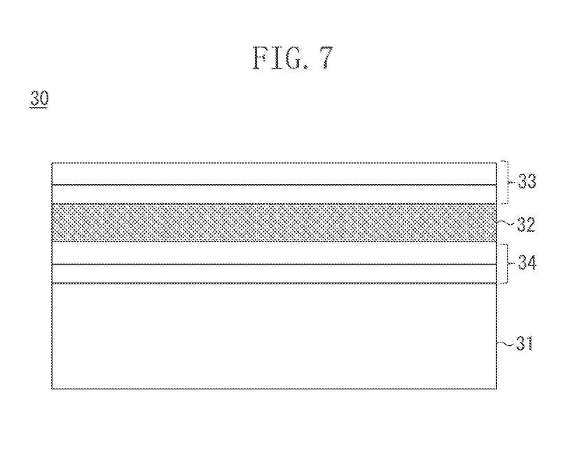

Next, an optical element 30 according to a third exemplary embodiment will be described. FIG. 7 illustrates a schematic view of the optical element 30 according to the present exemplary embodiment. The optical element 30 according to the third exemplary embodiment includes a substrate 31, an antireflection film 33 provided on the substrate 31, and an absorption layer 32 provided between the substrate 31 and the antireflection film 33. The optical element 30 according to the present exemplary embodiment is different from those in the first and second exemplary embodiments in that an intermediate film 34 is provided between the substrate 31 and the absorption layer 32. In the present exemplary embodiment, the intermediate film 34 includes two layers.

Details of each layer in the optical element 30 according to the third exemplary embodiment are described in Table 3.

TABLE 3

| Layer No. | n | k | d [nm] | Remarks |
|---|---|---|---|---|
| — | 1.00000 | 0.0000 | — | Air |
| 5 | 1.38941 | 0.0000 | 96.0 | Antireflection film |
| 4 | 2.11851 | 0.0000 | 76.2 | |
| 3 | 2.39576 | 0.0397 | 35.0 | Absorption layer |
| 2 | 1.45517 | 0.0000 | 22.4 | Intermediate film |
| 1 | 2.11851 | 0.0000 | 26.8 | |
| — | 1.60524 | 0.0000 | — | Substrate |

In the optical element 30 according to the present exemplary embodiment, the wavelength characteristic of the extinction coefficient of the absorption layer 32 is similar to that of the first exemplary embodiment, and is as illustrated in FIGS. 2A and 2B.

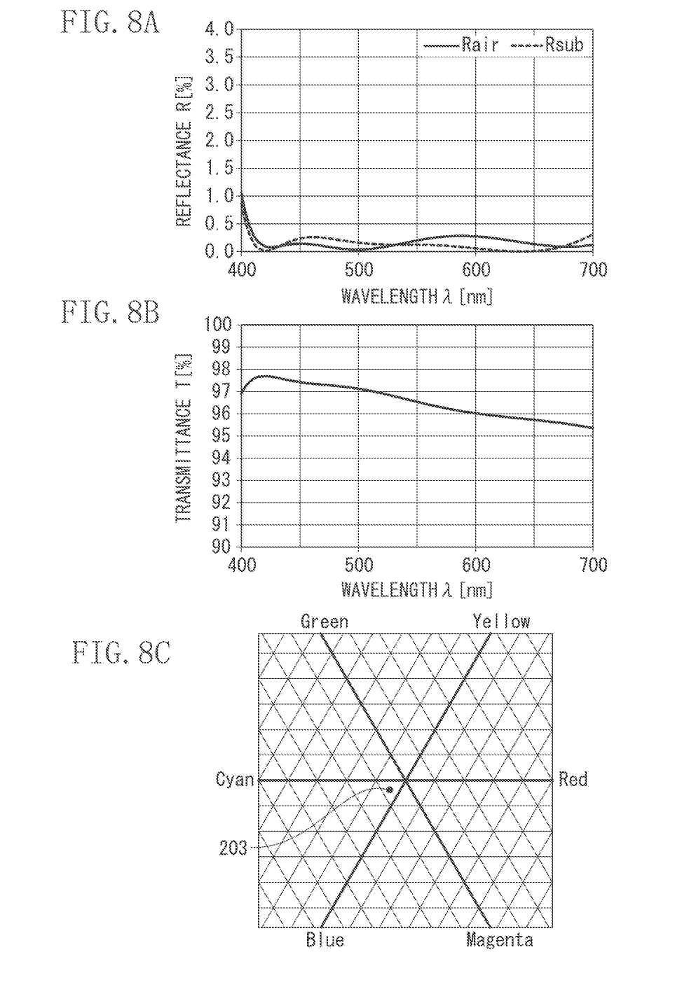

FIG. 8A illustrates the wavelength characteristic of the reflectance of the optical element 30 according to the present exemplary embodiment. As it illustrated in FIG. 8A, both Rₐᵢᵣ and R_{sub} of the optical element 30 according to the present exemplary embodiment are 1% or less at a wavelength of 450 nm to 650 nm. In addition, the change of Rₐᵢᵣ and R_{sub} with respect to the wavelength is small and the coloring of transmitted light due to the wavelength characteristic of the reflectance is extremely small.

FIG. 8B illustrates the wavelength characteristic of the transmittance of the optical element 30 according to the present exemplary embodiment. In the wavelength characteristic of the transmittance illustrated in FIG. 8B, the light absorption in the substrate 31 is regarded as zero. The transmittance of the optical element 30 according to the present exemplary embodiment is lower on the long-wavelength side than on the short-wavelength side. Therefore, by using the optical element 30 according to the present exemplary embodiment for the optical system, it is possible to correct the coloring of yellow transmitted light. The absorptance A₄₀₀ of the absorption layer 32 with respect to light having a wavelength of 400 nm is 0.0165.

FIG. 8C illustrates the result of evaluating the wavelength characteristic of the transmittance of the optical element 30 according to the present exemplary embodiment and the wavelength characteristic of the transmittance of only the substrate 31 used in the optical element 30 according to the present exemplary embodiment using the CCI and calculating the values of the expressions (7) and (8), the result being plotted with a black dot 203 on the trilinear coordinate system.

Next, an optical element according to a fourth exemplary embodiment will be described.

The optical element according to the present exemplary embodiment has a similar element configuration to the optical element 30 according to the third exemplary embodiment. In other words, the optical element according to the present exemplary embodiment includes an intermediate film, an absorption layer, and an antireflection film laminated in that order from the side of the substrate. In the present exemplary embodiment, the intermediate film includes two layers.

In the optical element according to the present exemplary embodiment, a wavelength characteristic of an extinction coefficient of the absorption layer is different from that of the optical element 30 according to the third exemplary embodiment. The wavelength characteristic of the extinction coefficient of the absorption layer in the present exemplary embodiment is the characteristic illustrated in FIGS. 3A and 3B.

Details of each layer in the optical element according to the fourth exemplary embodiment are described in Table 4.

TABLE 4

| Layer No. | n | k | d [nm] | Remarks |
|---|---|---|---|---|
| — | 1.00000 | 0.0000 | — | Air |
| 5 | 1.38941 | 0.0000 | 93.2 | Antireflection film |
| 4 | 2.11851 | 0.0000 | 112.6 | |
| 3 | 2.27112 | 0.1312 | 10.0 | Absorption layer |
| 2 | 1.45517 | 0.0000 | 31.3 | Intermediate film |
| 1 | 2.11851 | 0.0000 | 16.6 | |
| — | 1.60524 | 0.0000 | — | Substrate |

The extinction coefficient k(λ₅₅₀) of the absorption layer according to the present exemplary embodiment at a wavelength of 550 nm is 0.1312. In addition, when the extinction coefficient of the absorption layer according to the present exemplary embodiment is linearly approximated with respect to the wavelength by the least squares method and the gradient at this time with respect to the wavelength is “s”, the value of s·λ₅₅₀/k(λ₅₅₀) is 2.497. That is, the absorption layer according to the present exemplary embodiment satisfies the expression (5).

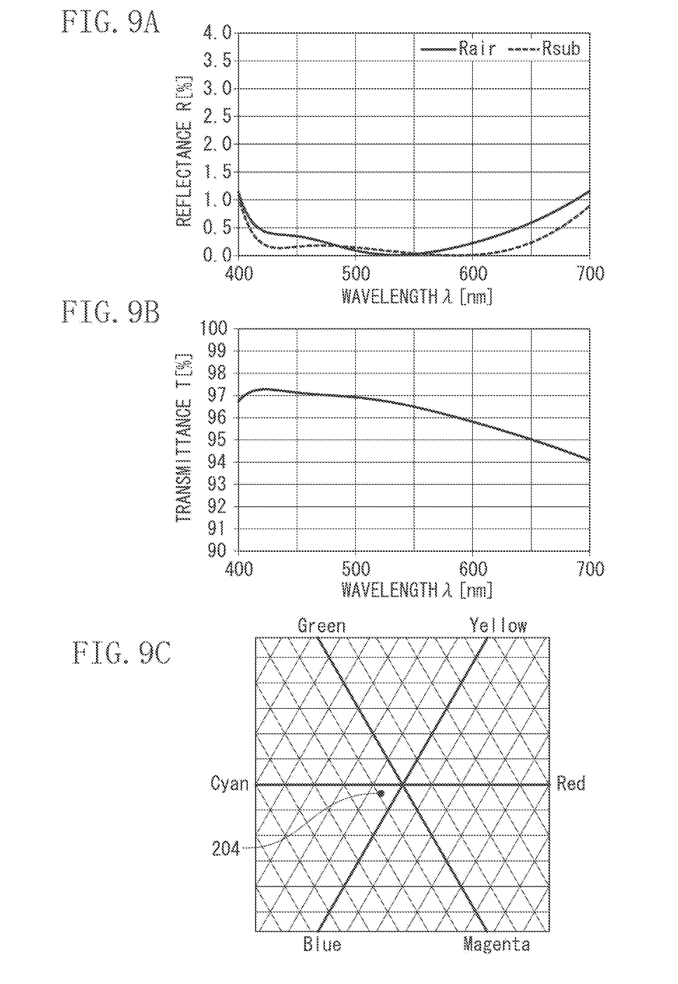

FIG. 9A illustrates the wavelength characteristic of the reflectance of the optical element according to the present exemplary embodiment. As illustrated in FIG. 9A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 9B illustrates the wavelength characteristic of the transmittance of the optical element according to the present exemplary embodiment. In the wavelength characteristic of the transmittance illustrated in FIG. 9B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.0162.

FIG. 9C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 204 on the trilinear coordinate system.

Next, an optical element according to a fifth exemplary embodiment will be described.

The optical element according to the present exemplary embodiment has a similar element configuration to the optical elements according to the third and fourth exemplary embodiments. In other words, the optical element according to the present exemplary embodiment includes an intermediate film, an absorption layer, and an antireflection film laminated in that order from the side of the substrate. In the present exemplary embodiment, the intermediate film includes two layers.

In the optical element according to the present exemplary embodiment, a wavelength characteristic of an extinction coefficient of the absorption layer is different from those in the third and fourth exemplary embodiments. The wavelength characteristic of the extinction coefficient of the absorption layer in the present exemplary embodiment is the characteristic illustrated in FIG. 4A.

Details of each layer in the optical element according to the fifth exemplary embodiment are described in Table 5.

TABLE 5

| Layer No. | n | k | d [nm] | Remarks |
|---|---|---|---|---|
| — | 1.00000 | 0.0000 | — | Air |
| 5 | 1.38941 | 0.0000 | 86.6 | Antireflection film |
| 4 | 2.11851 | 0.0000 | 42.4 | |
| 3 | 2.39576 | 0.0397 | 79.2 | Absorption layer |
| 2 | 1.45517 | 0.0000 | 19.5 | Intermediate film |
| 1 | 2.11851 | 0.0000 | 25.3 | |
| — | 1.60524 | 0.0000 | — | Substrate |

The extinction coefficient k(λ₅₅₀) of the absorption layer, at a wavelength of 550 nm, according to the present exemplary embodiment is 0.0397. In addition, when the extinction coefficient of the absorption layer according to the present exemplary embodiment is linearly approximated with respect to the wavelength by the least squares method and the gradient at this time with respect to the wavelength is “s”, the value of sλλ₅₅₀/k(λ₅₅₀) is 1.500. That is, the absorption layer according to the present exemplary embodiment satisfies the expression (5).

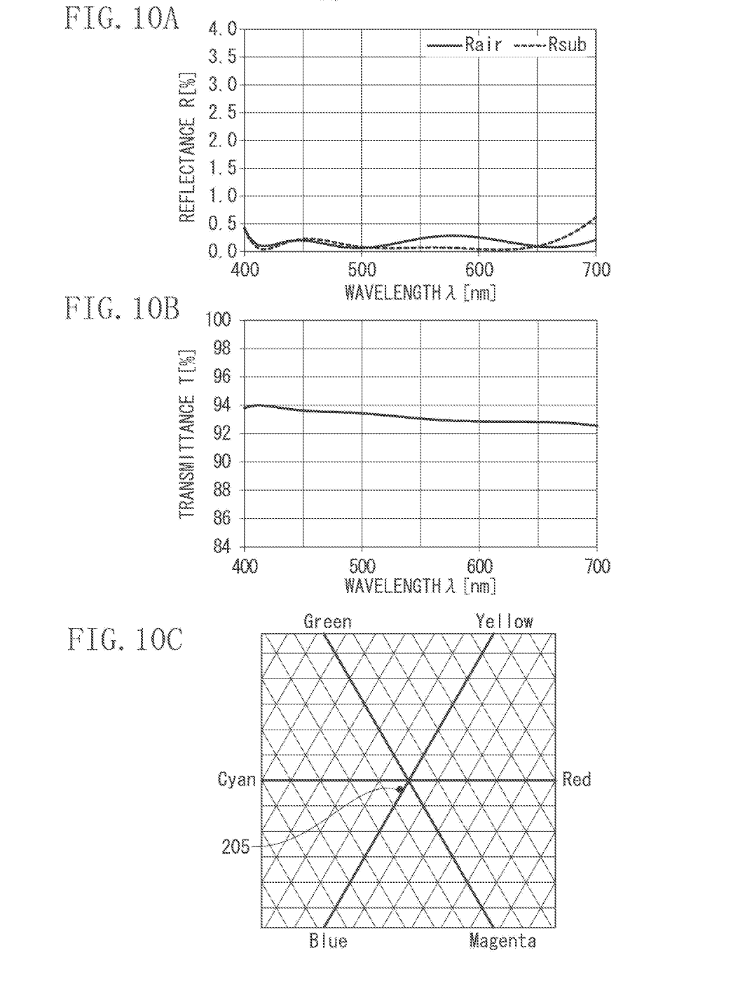

FIG. 10A illustrates the wavelength characteristic of the reflectance of the optical element according to the present exemplary embodiment. As illustrated in FIG. 10A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 10B illustrates the wavelength characteristic of the transmittance of the optical element according to the present exemplary embodiment. In the wavelength characteristic of the transmittance illustrated in FIG. 10B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.

FIG. 10C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 205 on the trilinear coordinate system.

Next, an optical element according to a sixth exemplary embodiment will be described.

The optical element according to the present exemplary embodiment has a similar element configuration to the optical elements according to the third to fifth exemplary embodiments. In other words, the optical element according to the present exemplary embodiment includes an intermediate film, an absorption layer, and an antireflection film laminated in that order from the side of the substrate. In the present exemplary embodiment, the intermediate film includes two layers.

In the optical element according to the present exemplary embodiment, a wavelength characteristic of an extinction coefficient of the absorption layer is different from those in the third to fifth exemplary embodiments. The wavelength characteristic of the extinction coefficient of the absorption layer in the present exemplary embodiment is the characteristic illustrated in FIG. 4B.

Details of each layer in the optical element according to the sixth exemplary embodiment are described in Table 6.

TABLE 6

| Layer No. | n | k | d [nm] | Remarks |
|---|---|---|---|---|
| — | 1.00000 | 0.0000 | — | Air |
| 5 | 1.33941 | 0.0000 | 95.0 | Antireflection film |
| 4 | 2.11851 | 0.0000 | 75.7 | |
| 3 | 2.39576 | 0.0397 | 32.5 | Absorption layer |
| 2 | 1.45517 | 0.0000 | 22.0 | Intermediate film |
| 1 | 2.11851 | 0.0000 | 26.6 | |
| — | 1.60524 | 0.0000 | — | Substrate |

The extinction coefficient k(λ₅₅₀) of the absorption layer according to the present exemplary embodiment at a wavelength of 550 nm is 0.0397. In addition, when the extinction coefficient of the absorption layer according to the present exemplary embodiment is linearly approximated with respect to the wavelength by the least squares method and the gradient at this time with respect to the wavelength is “s”, the value of s·λ₅₅₀/k(λ₅₅₀) is 9.607. That is, the absorption layer according to the present exemplary embodiment satisfies the expression (5).

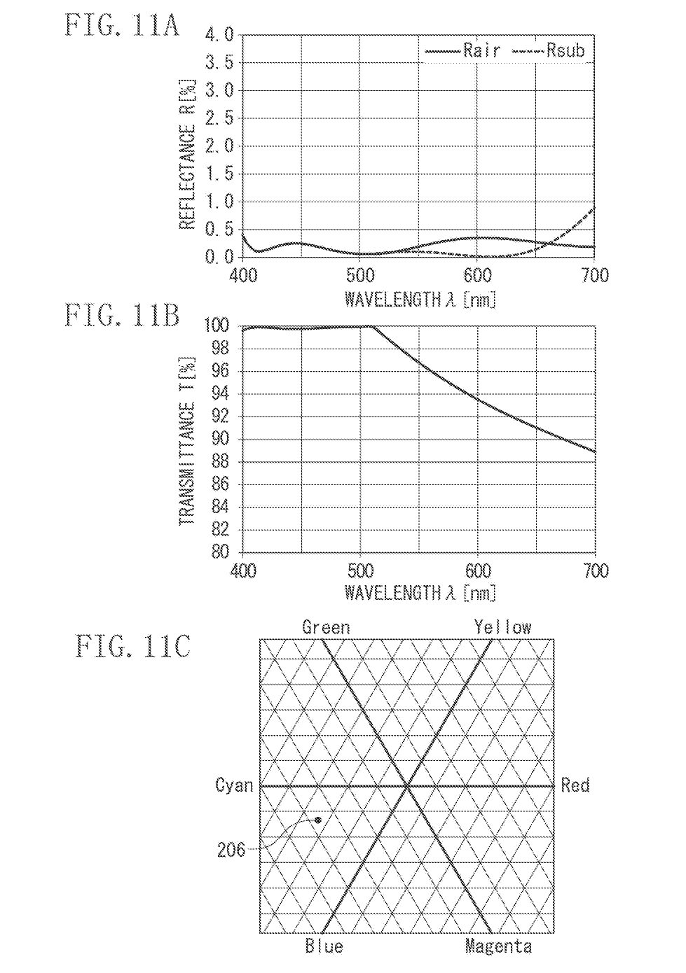

FIG. 11A illustrates the wavelength characteristic of the reflectance of the optical element according to the present exemplary embodiment. As illustrated in FIG. 11A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 11B illustrates the wavelength characteristic of the transmittance of the optical element according to the present exemplary embodiment. In the wavelength characteristic of the transmittance illustrated in FIG. 11B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.

FIG. 11C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 206 on the trilinear coordinate system.

Next, an optical element according to a seventh exemplary embodiment will be described.

The optical element according to the present exemplary embodiment has a similar element configuration to the optical elements according to the third to sixth exemplary embodiments. In other words, the optical element according to the present exemplary embodiment includes an intermediate film, an absorption layer, and an antireflection film in that order from the side of the substrate. In the present exemplary embodiment, the intermediate film includes two layers.

In the optical element according to the present exemplary embodiment, a wavelength characteristic of an extinction coefficient of the absorption layer is different from those in the third to sixth exemplary embodiments. The wavelength characteristic of the extinction coefficient of the absorption layer in the present exemplary embodiment is the characteristic illustrated in FIG. 4C.

Details of each layer in the optical element according to the seventh exemplary embodiment are described in Table 7.

TABLE 7

| Layer No. | n | k | d [nm] | Remarks |
|---|---|---|---|---|
| — | 1.00000 | 0.0000 | — | Air |
| 5 | 1.38941 | 0.0000 | 92.2 | Antireflection film |
| 4 | 2.11851 | 0.0000 | 63.3 | |
| 3 | 2.27112 | 0.0200 | 55.5 | Absorption layer |
| 2 | 1.45517 | 0.0000 | 22.5 | Intermediate film |
| 1 | 2.11851 | 0.0000 | 22.2 | |
| — | 1.60524 | 0.0000 | — | Substrate |

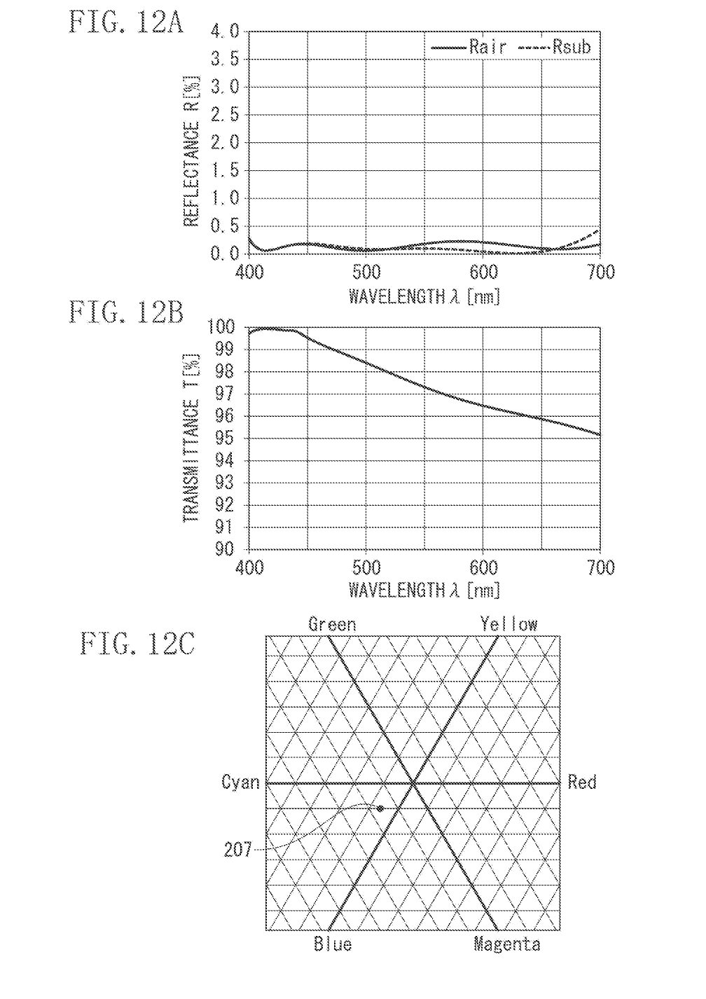

FIG. 12A illustrates the wavelength characteristic of the reflectance of the optical element according to the present exemplary embodiment. As illustrated in FIG. 12A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 12B illustrates the wavelength characteristic of the transmittance of the optical element according to the present exemplary embodiment. In the wavelength characteristic of the transmittance illustrated in FIG. 12B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorbance A₄₀₀ of the absorption layer with respect to light having a wavelength of 400 nm is 0.

FIG. 12C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 207 on the trilinear coordinate system.

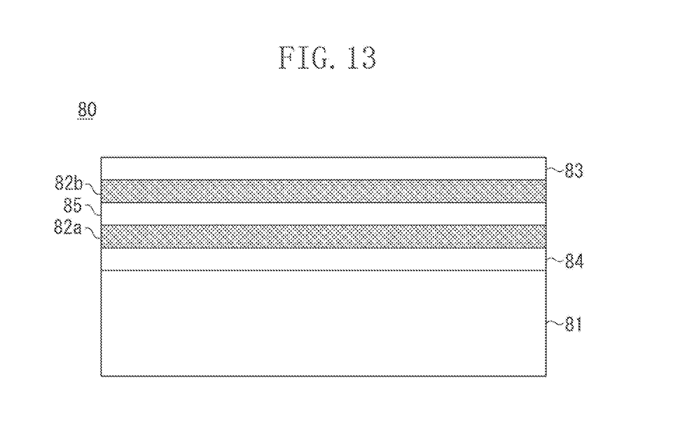

Next, an optical element according to an eighth exemplary embodiment will be described. FIG. 13 is a schematic view of an optical element 80 according to the eighth exemplary embodiment. Unlike the optical elements according to the first to sixth exemplary embodiments described above, the optical element 80 according to the present exemplary embodiment includes two absorption layers. In other words, the optical element 80 includes a first absorption layer 82a and a second absorption layer 82b. A layer 85 is formed between the first absorption layer 82a and the second absorption layer 82b. Part of light incident on the optical element 80 is absorbed by the first absorption layer 82a and the second absorption layer 82b. In FIG. 13, an antireflection film 83 includes one layer. In addition, an intermediate film 84 includes one layer.

Details of each layer in the optical element 80 according to the eighth exemplary embodiment are described in Table 8.

TABLE 8

| Layer No. | n | k | d [nm] | Remarks |
|---|---|---|---|---|
| — | 1.00000 | 0.0000 | — | Air |
| 5 | 1.38941 | 0.0000 | 106.9 | Antireflection film |
| 4 | 2.39576 | 0.0397 | 16.3 | Absorption layer |
| 3 | 1.63726 | 0.0000 | 49.3 | |
| 2 | 2.39576 | 0.0397 | 14.4 | Absorption layer |
| 1 | 1.63726 | 0.0000 | 89.6 | Intermediate film |
| — | 1.51805 | 0.0000 | — | Substrate |

The absorption layer according to the present exemplary embodiment has characteristics similar to those of the first and third exemplary embodiments, and a wavelength characteristic of an extinction coefficient is as illustrated in FIGS. 2A and 2B. Generally, in an antireflection film applied to an optical member, a layer having a relatively low refractive index (low refractive index layer) and a layer having a relatively high refractive index (high refractive index layer) are alternately laminated to enhance antireflection performance over a wide wavelength band. In the optical element 80 according to the present exemplary embodiment, as indicated in Table 8, the absorption layer is used as a high refractive index layer. In a case where the absorption layer is used as a high refractive index layer, the reflectance can be further reduced by increasing the refractive index of the absorption layer. Specifically, both the first absorption layer 82a and the second absorption layer 82b desirably have a refractive index of 2.0 or more at a wavelength of 550 nm.

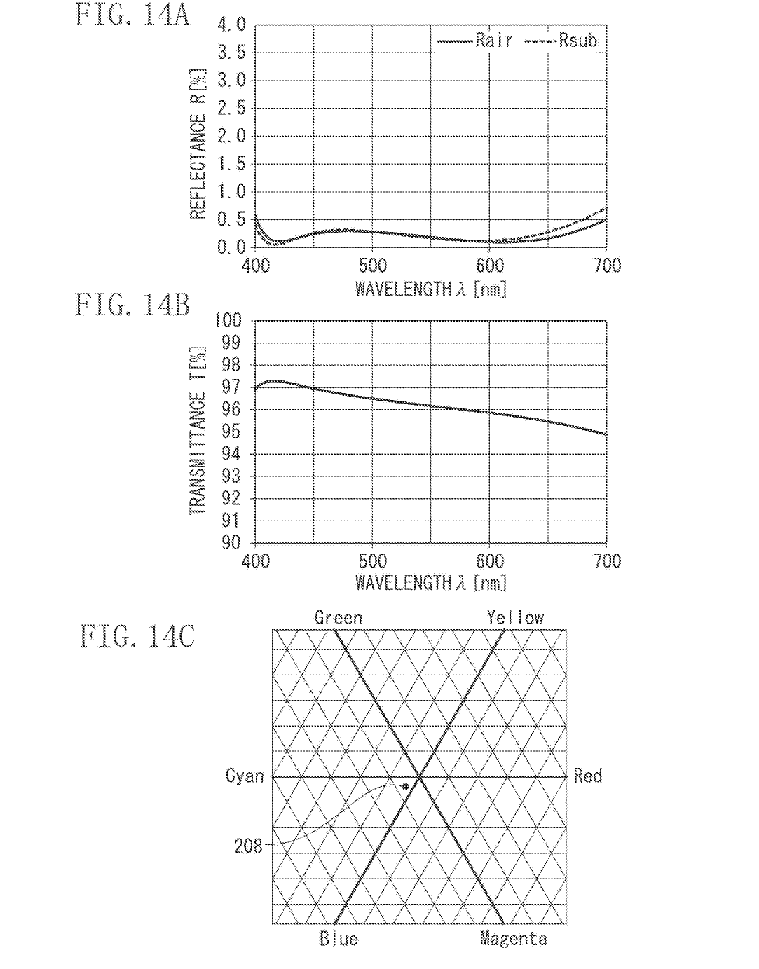

FIG. 14A illustrates the wavelength characteristic of the reflectance of the optical element according to the present exemplary embodiment. As illustrated in FIG. 14A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 14B illustrates the wavelength characteristic of the transmittance of the optical element according to the present exemplary embodiment. In the wavelength characteristic of the transmittance illustrated in FIG. 14B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.0145.

FIG. 14C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 208 on the trilinear coordinate system.

Next, an optical element according to a ninth exemplary embodiment will be described. The optical element according to the ninth exemplary embodiment has a similar element configuration to the optical element according to the eighth exemplary embodiment. In other words, the optical element according to the present exemplary embodiment includes two absorption layers with a layer having substantially no absorption function held therebetween.

Details of each layer in the optical element according to the present exemplary embodiment are described in Table 9.

TABLE 9

| Layer No. | n | k | d [nm] | Remarks |
|---|---|---|---|---|
| — | 1.00000 | 0.0000 | — | Air |
| 5 | 1.38941 | 0.0000 | 105.4 | Antireflection film |
| 4 | 2.27112 | 0.1312 | 19.9 | Absorption layer |
| 3 | 1.63726 | 0.0000 | 47.7 | |
| 2 | 2.27112 | 0.1312 | 18.1 | Absorption layer |
| 1 | 1.63726 | 0.0000 | 87.9 | Intermediate film |
| — | 1.51805 | 0.0000 | — | Substrate |

The absorption layer according to the present exemplary embodiment has characteristics similar to those of the fourth exemplary embodiment, and a wavelength characteristic of an extinction coefficient is as illustrated in FIGS. 3A and 3B.

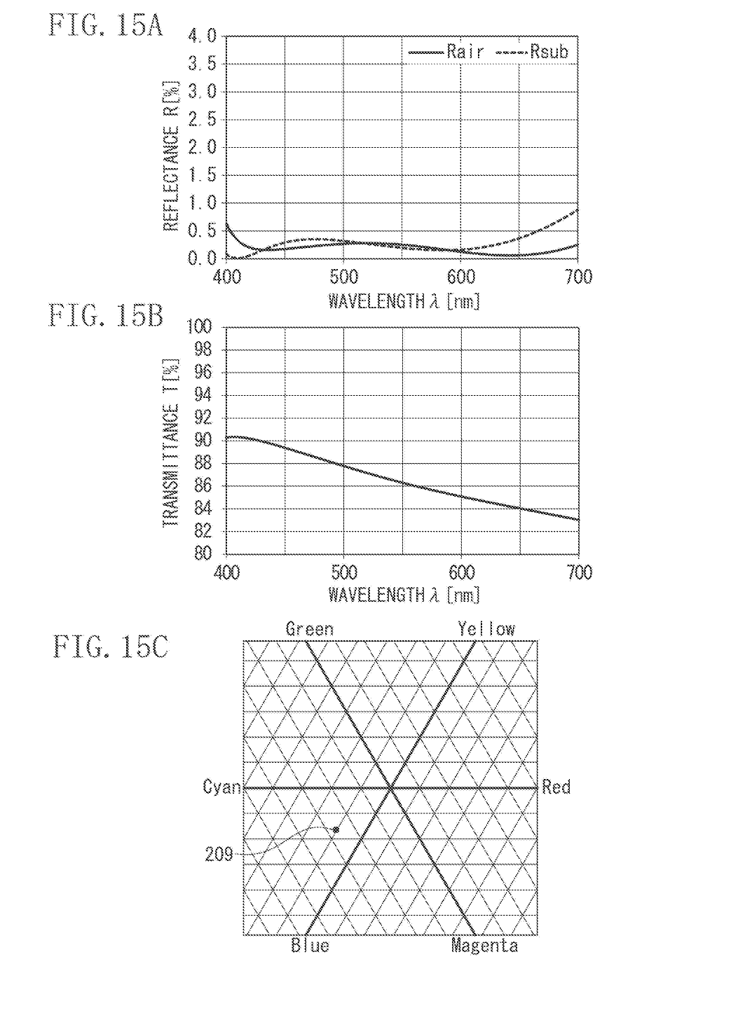

FIG. 15A illustrates the wavelength characteristic of the reflectance of the optical element according to the present exemplary embodiment. As illustrated in FIG. 15A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 15B illustrates the wavelength characteristic of the transmittance of the optical element according to the present exemplary embodiment. In the wavelength characteristic of the transmittance illustrated in FIG. 15B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.0605.

FIG. 15C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 209 on the trilinear coordinate system.

Next, an optical element according to a tenth exemplary embodiment will be described. The optical element according to the tenth exemplary embodiment has a similar element configuration to the optical elements according to the eighth and ninth exemplary embodiments. In other words, the optical element according to the present exemplary embodiment includes two absorption layers with a layer having substantially no absorption function held therebetween.

Details of each layer in the optical element according to the present exemplary embodiment are described in Table 10.

TABLE 10

| Layer No. | n | k | d [nm] | Remarks |
|---|---|---|---|---|
| — | 1.00000 | 0.0000 | — | Air |
| 5 | 1.38941 | 0.0000 | 105.6 | Antireflection film |
| 4 | 2.27112 | 0.0200 | 21.9 | Absorption layer |
| 3 | 1.63726 | 0.0000 | 44.7 | |
| 2 | 2.27112 | 0.0200 | 20.1 | Absorption layer |
| 1 | 1.63726 | 0.0000 | 89.6 | Intermediate film |
| — | 1.51805 | 0.0000 | — | Substrate |

The absorption layer according to the present exemplary embodiment has characteristics similar to those of the second and seventh exemplary embodiments, and a wavelength characteristic of an extinction coefficient is as illustrated in FIG. 4C.

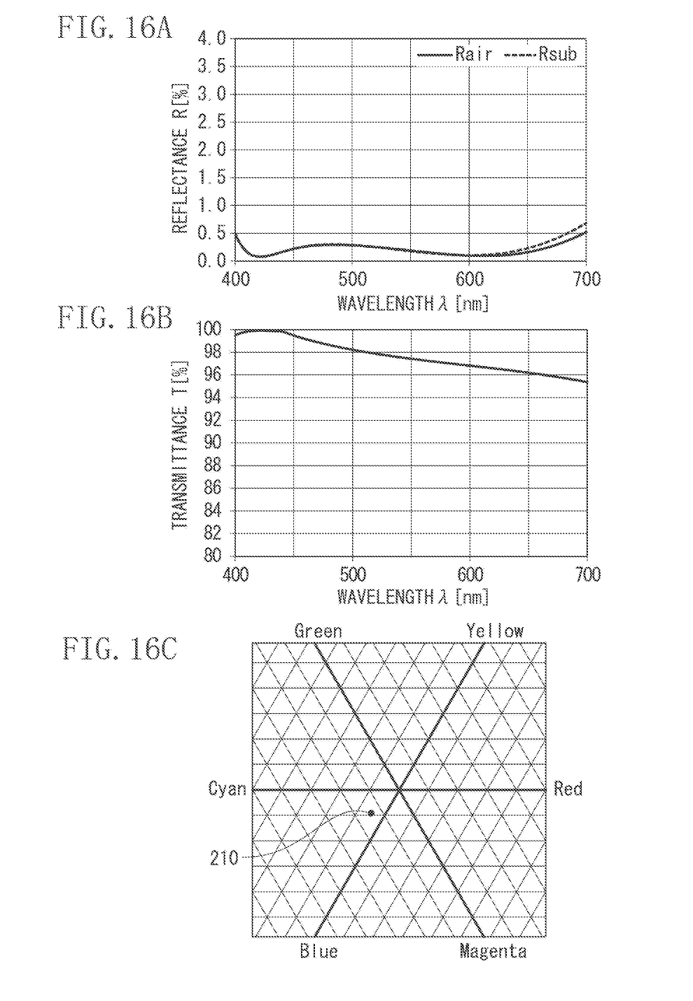

FIG. 16A illustrates the wavelength characteristic of the reflectance of the optical element according to the present exemplary embodiment. As illustrated in FIG. 16A, both Rₐᵢᵣ and R_{sub} of the optical element according to the present exemplary embodiment are 1% or less at a wavelength of 450 nm to 650 nm. In addition, the change of Rₐᵢᵣ and R_{sub} with respect to the wavelength is small, and the coloring of transmitted light due to the wavelength characteristic of the reflectance is extremely small.

FIG. 16B illustrates the wavelength characteristic of the transmittance of the optical element according to the present exemplary embodiment. In the wavelength characteristic of the transmittance illustrated in FIG. 16B, the light absorption in the substrate is regarded as zero. The transmittance of the optical element according to the present exemplary embodiment is lower on the long-wavelength side than on the short-wavelength side. Therefore, by using the optical element according to the present exemplary embodiment for the optical system, it is possible to correct the coloring of yellow transmitted light. The absorptance A₄₀₀ of the absorption layer with respect to light having a wavelength of 400 nm is 0.

FIG. 16C illustrates the result of evaluating the wavelength characteristic of the transmittance of the optical element according to the present exemplary embodiment and the wavelength characteristic of the transmittance of only the substrate used in the optical element according to the present exemplary embodiment using the CCI and calculating the values of the expressions (7) and (8), the result being plotted with a black dot 210 on the trilinear coordinate system.

The respective values in the optical elements according to the first to tenth exemplary embodiments described above are summarized in the following Table 11.

TABLE 11

| Sixth | Seventh | Eighth | Ninth | Tenth |
|---|---|---|---|---|
| exemplary | exemplary | exemplary | exemplary | exemplary |
| embodiment | embodiment | embodiment | embodiment | embodiment |
| 0.0397 | 0.0200 | 0.0397 | 0.1312 | 0.0200 |
| 9.607 | 4.718 | 2.579 | 2.497 | 4.718 |
| −1.12 | −0.86 | 0.31 | −1.40 | −0.78 |
| −3.03 | −1.12 | −0.47 | −1.86 | −0.96 |
| 0.0000 | 0.0000 | 0.0145 | 0.0605 | 0.0000 |
| — | — | — | — | — |

| | First | Second | Third | Fourth | Fifth |
|---|---|---|---|---|---|
| | exemplary | exemplary | exemplary | exemplary | exemplary |
| | embodiment | embodiment | embodiment | embodiment | embodiment |
| k₅₅₀ | 0.0397 | 0.0200 | 0.0397 | 0.1312 | 0.0397 |
| Expression (5) | 2.579 | 4.718 | 2.579 | 2.497 | 1.500 |
| Expression (8) | −0.70 | −1.01 | −0.30 | −0.25 | −0.28 |
| Expression (9) | −0.82 | −1.20 | −0.54 | −0.73 | −0.31 |
| A₄₀₀ | 0.0103 | 0.0000 | 0.0165 | 0.0162 | 0.0000 |
| \|N_{sub} − N_{abs}\| | 0.2800 | 0.1554 | — | — | — |

### [Optical System]

Next, an optical system according to an exemplary embodiment of the present invention will be described.

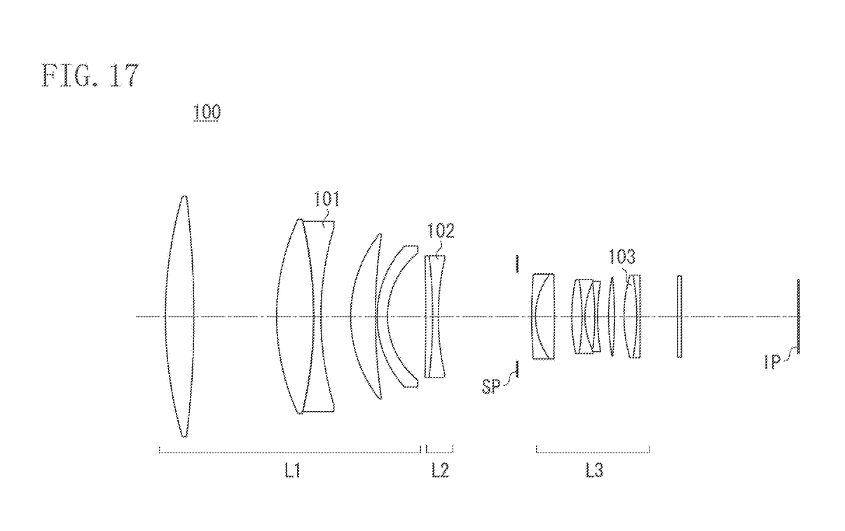

FIG. 17 is a cross-sectional view of an optical system 100 according to an exemplary embodiment of the present invention. In FIG. 17, the left side is an object side and the right side is an image side. The optical system 100 is used for an imagine apparatus such as a digital still camera.

The optical system 100 includes a plurality of lenses as optical elements. The optical system 100 includes a first lens unit L1 having positive refractive power, a second lens unit L2 having negative refractive power, an aperture stop SP, and a rear lens unit L3, which are disposed in that order from the object side. The second lens unit L2 moves during focusing. In FIG. 17, there is an image plane IP. In the optical system 100, image pickup elements such as a complementary metal oxide semiconductor (CMOS) sensor and a charge coupled device (CCD) sensor are disposed. In a case where the optical system 100 is used as an optical system of a film-type camera, a film is disposed on the image plane IP.

The optical system 100 uses a large number of lenses to improve optical performance. Furthermore, high-dispersion glass is used for the second lens unit. As described above, in the case where a large number of lenses or high-dispersion glass is used, light on the short-wavelength side is absorbed by the glass and the yellow coloring of transmitted light tends to become significant.

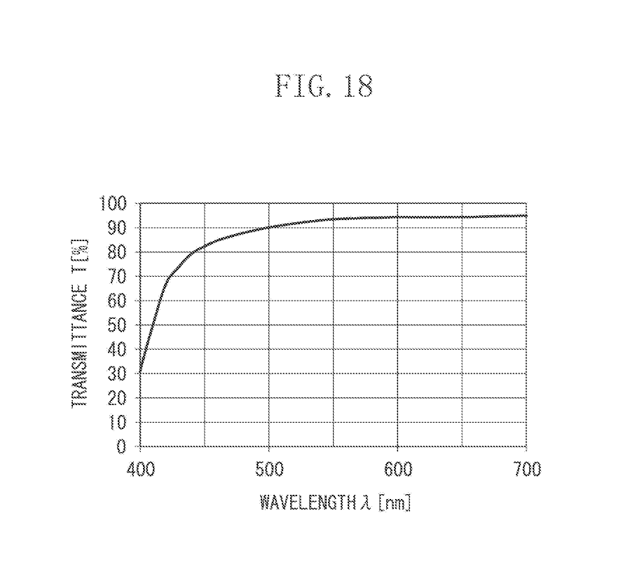

FIG. 18 illustrates a wavelength characteristic of transmittance in the optical system 100 in a case where only the absorption by glass is considered. It is assumed in FIG. 18 that there is neither reflection on the surface of each glass nor light absorption by a medium other than glass. As illustrated in FIG. 18, it is understood that the transmittance in the case of considering only the absorption by glass is small on the short-wavelength side, and transmitted light is colored yellow.

Therefore, in the optical system 100 according to the present exemplary embodiment, the coloring of transmitted light is corrected by using, as lenses, the optical elements having the absorption layers described in the first to tenth exemplary embodiments. Specifically, the intermediate film, the absorption layer, and the antireflection film having the layer structure indicated in Table 7 are provided on each of a lens surface of a third lens 101 on the object side, a lens surface of the third lens 101 on the image side, a lens surface of a seventh lens 102 on the image side, and a lens surface of a fourteenth lens 103 on the object side.

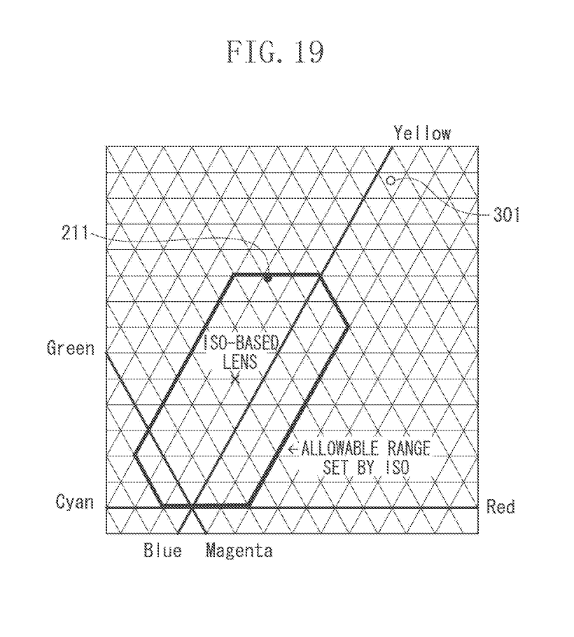

FIG. 19 illustrates the CCI (black dot 211) in the optical system 100 in a case of considering absorption by the absorption layers provided on the third lens 101, the seventh lens 102, and the fourteenth lens 103 and absorption by the glass. In FIG. 19, the coordinates indicated by a white dot 301 correspond to the CCI in a case where only the absorption by the glass in the optical system 100 is considered.

The coordinates indicated by a cross in FIG. 19 correspond to the CCI of an ISO-based lens. In addition, the hexagon indicated by the bold line is an allowable range set by ISO.

It is understood from FIG. 19 that the CCI in the case of considering only the absorption by the glass is colored to be largely deviated from the allowable range. On the other hand, the CCI in the case of considering the absorption by the absorption layer and the absorption by the glass is located inside the allowable range. This indicates that the coloring of transmitted light can be corrected by the absorption layers provided on the third lens 101, the seventh lens 102, and the fourteenth lens 103.

Furthermore, as illustrated in FIG. 12A, the third lens 101, the seventh lens 102, and the fourteenth lens 103 have low reflectance. Therefore, occurrence of ghost and flare can be reduced.

In the case where the optical elements having the absorption layers described in the first to tenth exemplary embodiments are provided in the optical system, the optical system desirably includes a lens having an Abbe number of 30 or less. High-dispersion glass having an Abbe number of 30 or less tends to absorb a relatively large amount of light on the short-wavelength side. Therefore, by providing the optical elements having the absorption layers described in the first to tenth exemplary embodiments in the optical system including glass having an Abbe number of 30 or less, the coloring of light passing through the optical system can be reduced.

The Abbe number νd is a value defined by the following expression (11):

νd=(nd−1)/(nF−nC) (11),

where nF, nd, and nC represent the refractive indices with respect to F-line (486.1 nm), d-line (587.6 nm), and C-line (656.3 nm) of the Fraunhofer lines, respectively.

In the case where the optical elements having the absorption layers described in the first to tenth exemplary embodiments are provided in the optical system, the optical system desirably satisfies both of the following conditional expressions (12) and (1:3).

5<CCI_{O,G}<20 (12)

4<CCI_{O,P}<20 (13)

In the expressions (10) and (11), CCI_{O,G} and CCI_{O,R} respectively represent the G value and the R value when the wavelength characteristic of the transmittance of the optical system considering only light absorption by the glass used in the optical system is expressed using the CCI. By providing the optical elements having the absorption layers described in the first to tenth exemplary embodiments in the optical system that satisfies both of the expressions (11) and (12), it is possible to effectively correct the coloring of transmitted light that may occur by glass absorbing the light, and to obtain an optical system with less coloring of transmitted light.

A numerical example of the optical system 100 illustrated in FIG. 17 is indicated below. In the surface data, r represents the curvature radius of each optical surface, and d (mm) represents the axial distance (distance on the optical axis) between the m-th surface and the (m+1)-th surface. Here, m is the number of the surface counted from the light incident side. Furthermore, n550 represents the refractive index of each optical member at a wavelength of 550 nm, and νd represents an Abbe number of the optical member.

In the numerical example, all of d, focal length (mm), F number, and half angle of view (°) are values obtained when the optical system 100 focuses on an infinite-distance object. The back focus BF is the distance from the last lens surface to the image plane. The total lens length is a value obtained by adding the back focus to the distance from the first lens surface to the last lens surface.

### NUMERICAL EXAMPLE

Unit mm
Surface data

| Surface number | r | d | n550 | νd |
|---|---|---|---|---|
| 1 | 251.287 | 16.40 | 1.48898 | 70.2 |
| 2 | −569.439 | 47.74 | | |
| 3 | 134.398 | 21.28 | 1.43484 | 95.1 |
| 4 | −239.479 | 0.24 | | |
| 5 | −237.555 | 4.00 | 1.61635 | 44.3 |
| 6 | 178.77 | 17.18 | | |
| 7 | 76.688 | 14.20 | 1.43484 | 95.1 |
| 8 | 318.525 | 1.03 | | |
| 9 | 60.263 | 6.00 | 1.51805 | 64.1 |
| 10 | 47.352 | 22.04 | | |
| 11 | −1630.821 | 4.00 | 1.93307 | 18.9 |
| 12 | −301.81 | 3.20 | 1.65762 | 39.7 |
| 13 | 149.471 | 45.57 | | |
| 14 (aperture) | ∞ | 8.36 | | |
| 15 | 327.772 | 2.18 | 1.72487 | 34.7 |
| 16 | 40.638 | 10.87 | 1.73200 | 54.7 |
| 17 | −927.465 | 10.02 | | |
| 18 | 103.249 | 5.93 | 1.85415 | 23.8 |
| 19 | −133.81 | 1.71 | 1.71582 | 53.9 |
| 20 | 45.777 | 5.62 | | |
| 21 | −155.221 | 1.67 | 1.88761 | 40.8 |
| 22 | 121.068 | 6.32 | | |
| 23 | 137.098 | 3.35 | 1.75400 | 35.3 |
| 24 | −256.865 | 5.53 | | |
| 25 | 85.03 | 7.34 | 1.65762 | 39.7 |
| 26 | −133.787 | 2.00 | 1.93307 | 18.9 |
| 27 | −3193.452 | 21.53 | | |
| 28 | ∞ | 2.20 | 1.51805 | 64.1 |
| 29 | ∞ | 67.57 | | |
| 30 (image plane) | ∞ | | | |

Various data

| | |
|---|---|
| Focal length | 390.06 |
| F number | 2.90 |
| Half angle of view (°) | 3.17 |
| Image height | 21.64 |
| Total lens length | 365.05 |
| BF | 67.53 |

The optical system according to the present invention is not limited to a photographic optical system used for a digital camera or the like, such as the optical system 100 illustrated in FIG. 17. The optical system according to an exemplary embodiment of the present invention may be an optical system of a telescope, a binocular, or a microscope, or a projection optical system used for a projector.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-233243, filed Nov. 30, 2016, which is hereby incorporated by reference herein in its entirety.

What is claimed is:

1. An optical element comprising:
a substrate;
an antireflection film provided on the substrate; and
an absorption layer that is provided between the substrate and the antireflection film and absorbs part of incident light,
wherein the following conditional expressions are satisfied:
0.01≤k(λ₅₅₀)≤0.15 and
k(λ₄₀₀)/λ₄₀₀)≤k(λ₇₀₀)/λ₇₀₀,
where k(λ) is an extinction coefficient of the absorption layer at a wavelength λ,
λ₄₀₀ is a wavelength of light having a wavelength of 400 nm,
λ₅₅₀ is a wavelength of light having a wavelength of 550 nm, and
λ₇₀₀ is a wavelength of light having a wavelength of 700 nm.

2. The optical element according to claim 1, wherein the incident light is visible light.

3. The optical element according to claim 1, wherein the following conditional expression is satisfied:
1.5≤s·λ₅₅₀/k(λ₅₅₀)≤10
where
λ₅₅₀ is a wavelength of light having a wavelength of 550 nm, and
s is a coefficient of λ when k(λ) is linearly approximated with respect to λ by the least squares method at a wavelength of 400 nm to 700 nm.

4. The optical element according to claim 1, wherein the absorption layer has a thickness of 8 nm or more.

5. The optical element according to claim 1, wherein the optical element has reflectance of 1% or less with respect to each wavelength from 450 nm to 650 nm when light is incident on the optical element from a side of the antireflection film toward the substrate.

6. The optical element according to claim 1, wherein the optical element has reflectance of 1% or less with respect to each wavelength from 450 nm to 650 nm when light is incident on the optical element from a side of the substrate toward the antireflection film.

7. The optical element according to claim 1, wherein the following conditional expression is satisfied:
0≤A₄₀₀≤0.1
where A₄₀₀ is absorptance of the absorption layer with respect to light having a wavelength of 400 nm.

8. The optical element according to claim 1, wherein the following conditional expressions are satisfied:
−4.6<(CCI_{e,G}−CCI_{sub,G})−(CCI_{e,B}−CCI_{sub,B})<0
−4<(CCI_{e,R}−CCI_{sub,P})−[(CCI_{e,G}−CCI_{sub,G})+(CCI_{e,B}−CCI_{sub,B})]×cos 60°<0
where CCI_{e,B} is a B value of the ISO color contribution index (ISO/CCI) of the optical element,
CCI_{e,G} is a G value of the ISO/CCI of the optical element,
CCI_{e,R} is an R value of the ISO/CCI of the optical element,
CCI_{sub,B} is a B value of the ISO/CCI of the substrate alone,
CCI_{sub,G} is a G value of the ISO/CCI of the substrate alone, and
CCI_{sub,R} is an R value of the ISO/CCI of the substrate alone.

9. The optical element according to claim 1, wherein the antireflection film includes a layer having a refractive index, at a wavelength of 550 nm, smaller than a refractive index of the absorption layer and larger than 1.

10. The optical element according to claim 1,
wherein the optical element includes the absorption layer at a position adjacent to the substrate, and
wherein the following conditional expression is satisfied:

|N_{sub}−N_{abs}|≤0.3
where N_{sub} is a refractive index of the substrate at a wavelength of 550 nm, and
N_{abs} is a refractive index of the absorption layer at a wavelength of 550 nm.

11. The optical element according to claim 1, further comprising an intermediate film between the substrate and the absorption layer,
wherein the intermediate film includes a layer having a refractive index at a wavelength of 550 nm which is between a refractive index of the absorption layer and a refractive index of the substrate.

12. An optical system comprising a plurality of optical elements,
wherein at least one of the plurality of optical elements is the optical element according to claim 1.

13. The optical system according to claim 12, wherein at least one of the plurality of optical elements is a lens having an Abbe number of 30 or less.

14. The optical system according to claim 12, wherein the optical system satisfies the following conditional expressions:
5<CCI_{O,G}<20 and
4<CCI_{O,R}<20,
where CCI_{O,G} and CCI_{O,R} are a G value and an R value, respectively, of the ISO color contribution index of the optical system when only absorption of light by glass used in the optical system is taken into account.

15. An optical element comprising:
a substrate;
an antireflection film provided on the substrate; and
an absorption layer that is provided between the substrate and the antireflection film and absorbs part of incident light,
wherein the absorption layer includes a titanium oxide with a ratio of oxygen atoms to titanium atoms smaller than 2 and equal to or larger than 1.5.

16. The optical element according to claim 15, wherein the incident light is visible light.

17. The optical element according to claim 15, wherein the absorption layer has a thickness of 8 nm or more.

18. An optical system comprising a plurality of optical elements,
wherein at least one of the plurality of optical elements is the optical element according to claim 15.

19. The optical system according to claim 18, wherein at least one of the plurality of optical elements is a lens having an Abbe number of 30 or less.

20. The optical system according to claim 18, wherein the optical system satisfies the following conditional expressions:
5<CCI_{O,G}<20
4<CCI_{O,R}<20
where CCI_{O,G} and CCI_{O,R} are a G value and an R value, respectively, of the ISO color contribution index of the optical system when only absorption of light by glass used in the optical system is taken into account.
